(19) United States
(12) Patent Application Publication
(10) Pub. No.: US 2012/0200961 A1
(43) Pub. Date: Aug. 9, 2012

(54) ELECTRIC TRANSFORMER EXPLOSION PREVENTION DEVICE PROVIDED WITH A LIQUID DETECTOR

(76) Inventor: Philippe Magnier, Kingwood, TX (US)

(21) Appl. No.: 13/368,903

(22) Filed: Feb. 8, 2012

Related U.S. Application Data
(60) Provisional application No. 61/440,722, filed on Feb. 8, 2011.

(51) Int. Cl. H02H 7/04

(52) U.S. Cl. 361/37

(57) ABSTRACT

Device for preventing the explosion of an electrical transformer provided with a tank which is filled with a coolant liquid. The device includes a rupture element provided with tear areas and folding areas at breaking. The rupture element is able to break when the internal tank pressure exceeds a predetermined threshold. At least one flange for maintaining the rupture element, the said flange being arranged at side of the rupture element opposite the tank. The device comprises a liquid detector arranged at the side of the rupture element opposite the tank.

### PRIORITY CLAIM

This application claims the benefit of U.S. Provisional Application No. 61/440,722 filed on Feb. 8, 2011.

### BACKGROUND OF THE INVENTION

1. Field of the Invention

The present invention concerns the field of prevention of explosions of electric transformers cooled by a volume of combustible fluid.

2. Description of the Relevant Art

The applicant realized the number of transformer's explosions increases faster than the stock in installation and with a decorrelation with the transformer's age. To remake transformers heavily shielded seems to be unrealistic with actually soft rules about construction quality. But transformer's explosions cause more than hundred deaths by year in the world and lot of atmospheric and ground pollutions.

Electric transformers sustain losses in the winding and the iron parts, requiring the heat produced to be dissipated. Thus, high-power transformers are generally cooled by a fluid such as oil. The oils are dielectric and are capable of igniting above a temperature about 140° C. Since transformers are very expensive devices, particular attention must be paid to protecting them. An insulation fault generates, in the first instance, a strong electric arc prompting action by the electrical protection systems which trigger the transformer power cubicle (circuit breaker). The electric arc also result in a diffusion of energy causing gases, in particular hydrogen and acetylene, to be discharged through decomposition of the dielectric oil.

After the gas discharge, the pressure inside the transformer tank increases very rapidly, leading to an often very violent deflagration. The deflagration causes significant tearing of the mechanical linkages of the transformer tank (bolts, welds) placing the said gases in contact with the oxygen in ambient air. Since acetylene self-ignites in the presence of oxygen, a fire breaks out immediately and spreads to other items of equipments on the site which are also likely to contain large quantity of combustible substances.

Explosions are caused by insulation ruptures due to short-circuits caused by overloads, voltage surges, gradual deterioration of the insulation, insufficient oil level, the presence of water or mold or failure of an insulation component.

In the prior art, fire extinguishing systems for electric transformers were activated by fire detectors. However these systems operated with a significant lag, when the transformer oil was already burning. We contented to merely restrict the fire outbreak to the equipment concerned so as to try not spreading the fire to the neighboring installations.

The document WO 97/12379 introduced for the first time a method for preventing explosion and fire in an electric transformer equipped with the tank filled with combustible coolant fluid, by the detection of a rupture in the electrical insulation of the transformer using a pressure sensor, depressurization of the coolant fluid contained in the tank using a valve, and cooling of the hot parts of the coolant fluid by injecting a pressurized inert gas in the bottom of the tank in under to agitate the said fluid and to prevent oxygen from penetrating the transformer tank. This method is satisfactory and prevents the transformer tank from exploding.

The document WO 00/57438 described a rupture element with rapid opening for an electric transformer explosion prevention device.

The document WO 2007/003736 described an improved device allowing an extremely quickly depressurization of the tank to increase the probability of integrity saving of the transformers, on-load tap changers and feedthroughs by using simply shaped elements. This type of installation saved lot of human lives.

### SUMMARY OF THE INVENTION

The invention improves the situation.

During his search the applicant realized that the liquid presence downstream of a rupture element without the device being triggered. The applicant, to prevent a possible reduction of efficacy by the liquid presence, sought to avoid the liquid presence. The accumulation of liquid at this place could, in extreme cases, modify the triggering threshold of the device, increasing the load loss after the release and/or accelerating the corrosion phenomena.

The electrical transformer is provided with a tank which is filed with a coolant liquid, for example oil. The device comprises a rupture element provided with tears areas and folding areas at breaking The rupture element is able to break up when the internal tank pressure exceeds a predetermined threshold. The device comprises at least one flange for maintaining the said rupture element, arranged at a side of the rupture element opposed to the tank. The device comprises a liquid detector arranged at the side of the rupture element opposed to the tank. The liquid detector could comprise a liquid sensor.

The liquid detector could be arranged in a hole provided in the flange. The liquid detector is arranged as close as possible to the rupture element to detect as soon as possible a leak of the rupture element.

The liquid detector could comprise a tubular body having an external thread. The disassembly is easy and fast during maintenance. The liquid detector could comprise a liquid display window which allows seeing the liquid presence, for example to quickly estimate the leak extent.

The liquid detector could comprise an upper leg supporting a liquid sensor, and a lower leg provided with a bleed valve. The upper leg and lower leg could be perpendicular. A device is provided with some structurally independent functionalities and some structurally independent elements to make the maintenance easy.

The bleed valve could be closed in a home position, i.e. in normal service and in open position to bleed. This allows maintaining tightness between the outlet rupture element and the external atmosphere in case of rupture of the said rupture element.

The rupture element could be cambered opposite the tank. This shape is adapted of the mechanical reaction chosen for the rupture element during the rupture in the only way of the rupture.

The flange could include a groove for collecting the liquid near the rupture element. The groove could lead the liquid flow to the active part of the liquid detector to detect as soon as possible a possible leak.

The prevention system against electrical transformers explosion provided with at least one tank containing coolant liquid comprises a device as described previously in fluid communication with the tank. The tank contains main windings, an on-load tap changer, or a feedthrough.

The system could comprise a conservator in communication with the tank by a first pipe. A gas sensor could be mounted on the first pipe.

The system could comprise a passive degassing component of an area upstream of the rupture element. The passive degassing component could be in communication with the gas sensor. The gas sensor could be sensitive to gas of degasification. It is possible to degas a zone upstream the rupture element, to detect presence of gas which can be indicator of dysfunction. A second gas sensor becomes optional by linking the first pipe and the area located upstream the rupture element.

The passive degassing component could be in a constant active state. This makes it possible to avoid operator intervention. The gas sensor could be located at an altitude higher than the rupture element. Gases of degasification moved by buoyancy are detected. An automatic valve can be mounted on the first pipe between the conservator and the gas sensor. This makes it possible to control the flow of cooling liquid to the tank and/or the fluidic insulation of the conservator from the remaining elements of the device.

The passive degassing component could comprise an end laid out in a zone upstream of the rupture element and near the rupture element with a distance lower than seventy millimeters. This makes it possible to degas gases of degasification accumulated near the rupture element as soon as little volume of the said gas is present.

The passive degassing component could comprise an end fixed near the rupture element. The two elements are secured together. The passive degassing component could comprise an end, fixed to the first pipe. The passive degassing component could comprise a monotone gradient tube. The passive degassing component could be manufactured quickly and at low cost and be adaptable on the existing devices.

The liquid detector could comprise a T-tube or a X-tube including an upper leg supporting the liquid sensor and a lower leg supporting a bleed valve. This allows an operator to reboot easily the liquid detector after a liquid detection.

The space located upstream of the depressurization chamber and the first pipe could include a common section near the tank. This makes it possible to reduce the volume of the system by minimizing the number of elements, particularly for a device located above the tank.

The passive degassing component could comprise a connection with a component to make partial vacuum. This connection makes it possible to create a partial vacuum in the tank and reduce the consequences of pressure gradient. The presence of oxygen or flammables gases is limited. The passive degassing component could be drained of possible dangerous gases during maintenance.

The first pipe could comprise a second degassing component fluidly connected to a first drainage pipe or to a collection tank. It is possible to drain a volume of fluid located above the tank directly downstream from the tank in the event of overpressure.

The device could comprise a tube for injecting inert gas by the bottom of the tank. The said pipe could be provided with a non-return valve near the tank. This prevents the draining the cooling liquid contained in the tank by the gas injection pipe, particularly in the event of a bad handling which broken the said pipe.

The depressurization chamber can be supported by at least one damper supported by a bracket fixed to the tank or to the ground. The vibrations of the transformer are at least partially absorbed by the damper instead of being transmitted to the depressurization chamber.

The reliability of the prevention is increased. This is all the more important as the lifespan of the transformers is going down year by year, the occurrence of the short-circuit increasing.

The device makes moreover possible the liquid detection and the preventive intervention.

The device reduces the risk of factors interfering with the rupture element.

The device prevents the explosion of an electric transformer by a rupture element ready to break up when a threshold of internal pressure to a tank is exceeded. The device prevents consequences of a leak near the rupture element, by liquid detection.

The explosion prevention device is particularly well suited for electric transformers located in confined areas, for example tunnels, mines or underground in a built-up area.

### BRIEF DESCRIPTION OF THE DRAWINGS

The present invention will be better understood by reading the detailed description of embodiments given by way of entirely non-limiting examples, and illustrated by the accompanying drawings in which:

FIG. 1 is a schematic view of a fire prevention device;

FIG. 2 is a schematic view of the cross-section of a rupture element;

FIG. 3 is a transverse cross-section view of a rupture element;

FIG. 4 is a view of the top, from downstream of the rupture element;

FIG. 5 is a view of the lower part, from the upstream of a rupture element;

FIG. 6 is a schematic partial view of the interior of a tube section located downstream the rupture element;

FIG. 7 is an exploded view of a liquid detector;

FIG. 8 is a schematic view of a part of the device;

FIG. 9 is a detailed view of the protection device;

FIG. 10 is a view of an alternate of an embodiment to FIG. 9;

FIG. 11 is a view of a vertical alternative of FIG. 9;

FIG. 12 is a view of an alternative of FIG. 11;

FIG. 13 is view of an alternate of an embodiment to FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

By words “normal” or “conventional operation” it should be understand here the energy conversion by the transformer. The words “upstream” and “downstream” has to be understood in a direction of displacement of the oil from the tank to the outside.

The electric transformer 1 includes a tank 2 and main windings 90 arranged in the tank 2. The tank 2 rests on the ground 3 by feet 4. The electric transformer 1 comprises feedthrougs 91.

Main windings 90 are fed in electric power via feedthroughs 91 surrounded by insulators. The feedthroughs 91 protrude from the tank 2. The feedthroughs 91 are fed via electrical lines 5. The electrical lines 5 are supplied by a supply cell 38, which includes means of power supply cut-off such as circuit breakers and triggering sensors. The circuits breakers could be triggered by a differential relay, cf. U.S. Pat. No. 4,441,134.

The tank 2 includes a body 2a and a lid 2b. The tank 2 is filled with dielectric coolant liquid 7, for example oil. To ensure a constant level of coolant liquid 7, for example a full filling, in tank 2, the electric transformer 1 is equipped with a conservator 8, also named auxiliary tank, connected to the tank 2 by a first pipe 9. The conservator 8 is located above the tank 2. The supply of cooling liquid is useful in particular because of the thermal dilatation of tank 2 and of the cooling liquid 7 in service.

The first pipe 9 can equipped with an automatic valve 10 to close the first pipe 9 in case of rapid movement of the cooling liquid 7. In service or during filling of the tank 2, the automatic valve 10 is open. The automatic valve 10 is autonomous. The automatic valve 10 has a mechanical working. The automatic valve 10 can be linked to sensors. The automatic valve 10 can be locked in open opposition during the filling of the tank 2. At the time of a fast movement of liquid in the first pipe 9, the automatic valve 10 is closing. Drainage of the cooling fluid 7 in the conservator 8 is avoided. In the event of rupture of the rupture element, this avoids to evacuate an additional volume of combustible liquid. This type of valve is sold by Sergi since the 60's.

For example a valve according to IT 1 226 525 can be used. The valve includes an inlet pipe and an outlet pipe connected by a rectangular compartment. A mobile valve is mounted in the compartment, pivotal around an axis and lockable by a lever during maintenance. The mobile valve is provided with a seal and subjected to the flow of a liquid flowing through the compartment. The mobile valve can stop or reduce flow between the two pipes. A handle external to the compartment is swiveled in an anti-clockwise direction to open the mobile valve during maintenance. In service, when the flow increases brutally, the mobile valve is moved by the flow in closed position. The position of the lever indicates the “active” state or the “in maintenance” state. The action on the lever can be indirect, for example via a switch connected to a control unit. A drainage valve for air is laid out in the top of the compartment.

The first pipe 9 can be provided with a gas sensor 55. The gas sensor 55 is able to detect gases in the first pipe 9. The gas sensor 55 is located between the said automatic valve 10 and the tank 2. The gas sensor 55 can be a Buchholz.

The slowness of reaction of Buchholz relays is a defect known since at least 1964 (cf FR 1 415 293). Buchholz are sensitive to bubbles of slow degasification of oil by of a float. Buchholz includes a flap which can be activated by a displacement of liquid in the first pipe 9. Nevertheless many transformers equipped with Buchholz exploded, Buchholz being inefficient for fast phenomena.

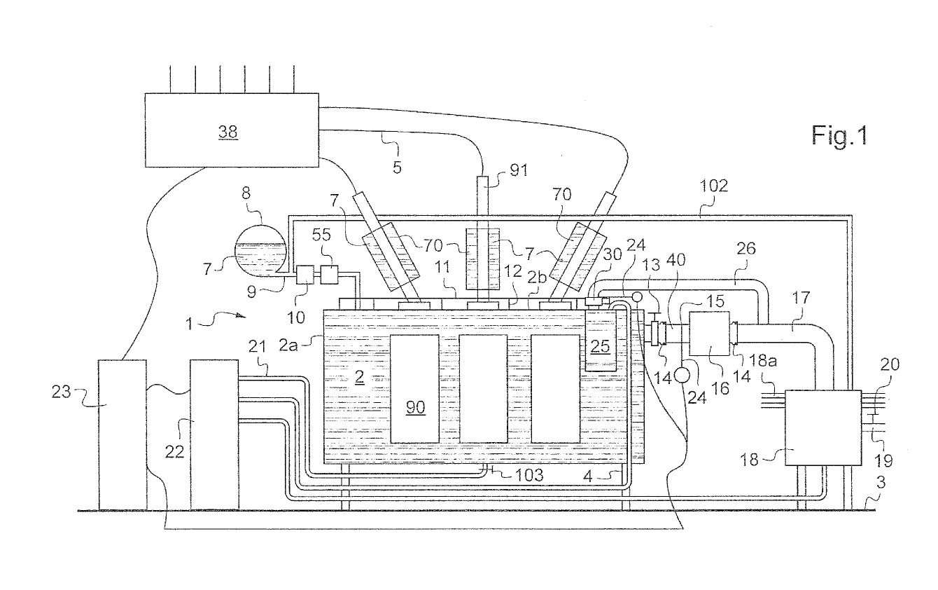

The tank 2 can also equipped with one or more fire detectors 11. As shown on FIG. 1, a fire detector 11 is fitted above the tank 2 and is supported by blocs 12 resting on the lid 2b. A distance of a few centimeters separates the fire detector 11 from the lid 2b. The fire detector 11 can include two wires separated by a synthetic membrane with a low melting point, both wires coming into contact when the membrane has melted. The fire detector 11 can be laid out in a rectangular path near the edge of the tank 2.

The tank 2 includes a system for cooling the liquid 7 by injecting an inert gas, such as nitrogen, in the bottom of the tank 2. The inert gas is stored in a pressurized reservoir equipped with a valve, an expansion valve or a pressure reducer and a hose 21 conveying the gas to the tank 2. The pressurized reservoir is housed in a cabinet 22. The injection hose 21 includes, near the tank 2, a non-return valve 103. The non-return valve 103 lets a path of inert gas in the direction of the tank 2. The non-return valve 103 closes a path of the liquid to the outside of the tank 2. The non-return valve 103 prevents an accidental draining of the tank in the event of a rupture of the hose 21 or a fortuitous opening of an end opposite the tank 2. The non-return valve 103 can be linked and controlled by a control unit 23.

The prevention device includes a maintenance valve 13, cf. FIG. 1. The prevention device includes a first elastic sleeve 14. The prevention device includes a rupture element 15. The prevention device includes a liquid detector 24. The prevention device includes a depressurization chamber 16. The prevention device includes a second elastic sleeve 14. The prevention device includes a first drainage pipe 17. The prevention device includes a collection reservoir 18. The prevention device can includes the above mentioned elements in this order from the tank 2, in other words, from upstream to downstream.

The maintenance valve 13 is mounted on an outlet of the tank 2, laid out here in a high point of the body 2a. To close the maintenance valve 13 at the time of the maintenance and in particular during the filling of the tank 2, allows isolating the elements located downstream of the said maintenance valve 13. The isolating makes it possible to operate on said elements without having to empty the tank 2 of its cooling liquid 7. Among the said elements, the rupture element 15 is isolated. In normal operation, the maintenance valve 13 is open.

The first elastic sleeve 14, absorbing vibrations, is mounted downstream from the maintenance valve 13. The first elastic sleeve 14 is mounted upstream of the rupture element 15. The first elastic sleeve 14 is generally shaped as a pleated section. The first elastic sleeve 14 is generally wrinkled The first elastic sleeve has a tight structure. The first elastic sleeve is made of a tight material. The first elastic sleeve 14 is configured to ensure the sealing with outside, between the maintenance valve 13 located upstream and the rupture element 15 located downstream. The first elastic sleeve 14 can undergo significant elastic strain. The first elastic sleeve 14 is configured to reduce the vibration between the maintenance valve 13 located upstream and the rupture element 15 located downstream. The elastic sleeve can include materials chemically resistant to the coolant liquid 7 and having anti-fire properties, for example, Polytetrafluoroethylene (PTFE).

The rupture element 15 is located downstream the first sleeve 14. The rupture element 15 is located upstream the liquid detector 24 and the depressurization chamber 16. The rupture element 15 is adapted to be mounted on an outlet of the tank 2. In the embodiment of FIG. 1, the first elastic sleeve 14 is disposed between the outlet of the tank 2 and the rupture element 15.

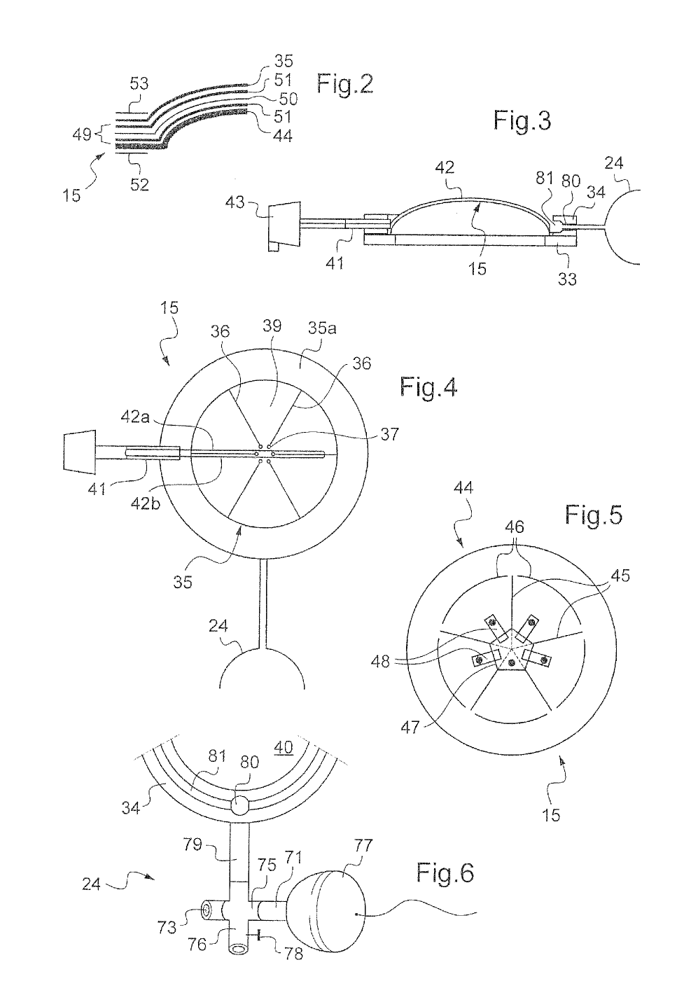

As shown on FIGS. 3 to 5, the rupture element 15 is of convex domed circular shape in one embodiment. The rupture element 15 is clamped between two disc-shaped flanges 33, 34, cf. FIG. 3. Each disc-shaped flange 33, 34 is secured together with an element upstream, respectively downstream, the rupture element 15. The rupture element 15 includes a retaining part 35, cf. FIGS. 2 and 4, in the form of a thin metal sheet, for example made of stainless steel, aluminum or aluminum alloy. The thickness of the retaining part 35 may be between 0.05 mm and 0.25 mm The retaining part 35 has radial grooves 36 dividing it into several portions, cf. FIG. 4. The radial grooves 36 constitute tearing areas. The radial grooves 36 are formed in recesses in the thickness of the retaining part 35 such that a rupture is made by the tearing of the retaining part 35 at its centre and such that this happens without fragmentation in order to prevent fragments of the rupture element 15 from being broken off and moved by the fluid passing through the rupture element 15 and running the risk of damaging a pipe located downstream.

The retaining part 35 is provided with through-holes 37 of very small diameter arranged one per radial groove 36 near the centre of the retaining part 35. In other words, several through-holes 37 are arranged, for example hexagonally if there are 6 radial grooves 36, as shown on FIG. 4. The through-holes 37 form tear initiation sites of low strength and ensure that the tearing starts at the centre of the retaining part 35. The formation of at least one through-hole 37 per radial groove 36 ensures that the radial grooves 36 will separate simultaneously, providing the largest possible passage cross section. As a variant, a number of radial grooves 36 different from six could be envisaged, and/or several through-holes 37 per groove 36. A sealing part 49 comprising an impermeable coating 50 is able to blocking the through-holes 37.

The break pressure of the rupture element 15 is determined, in particular, by the diameter and position of the through-holes 37, the depth of the radial grooves 36, and the thickness and composition of the material forming the retaining part 35. Preferably, the radial grooves 36 are formed over the entire thickness of the retaining part 35. The remainder of the retaining part 35 may have a constant thickness. Two adjacent radial grooves 36 form a disk-part 39. The disk-part 39 includes a first side corresponding with a radial groove 36, a second side corresponding with another radial groove 36 and a third side designed in arc. The disk-parts 39 are connected to the inside of a ring 35a included in the retaining part 35, via the said third side designed in arc. The ring 35a is disposed between disc-shaped flanges 33, 34. The ring 35a has not radial groove 36. The disk-part 39, during rupture, will be separated from the neighboring disk-parts 39 by the tearing of the material between the through-holes 37 and will be distorted towards the downstream direction by folding. The disk-parts 39 fold, near the said third side designed in arc, without tearing to prevent the breaking off of the said disk-parts 39 from the ring 35a, which are capable of damaging a downstream pipe or disturbing the flow in the downstream pipe thus increasing the head loss and slowing down the depressurization process on the upstream side. In other words, after the rupture element 15 being ruptured, disk-parts 39 open as flower petals. The disk-arts 39 stay integral with the ring 35a. The rupture of the rupture element 15 could be understood as a burst of its central part. The said burst has to be understood as no producing splinters splitting from the ring 35a. The retaining part 35 stays integral. The number of grooves 36 also depends on the diameter of the rupture element 15.

The disc-shaped flange 34 arranged downstream the disc-shaped flange 33 includes a radial hole formed through it, into which hole there is arranged a protective tube 41, cf. FIG. 3. The disc-shaped flange 34 arranged downstream the disc-shaped flange 33 has a radial hole formed through it, into which hole there is arranged a liquid detector 24.

The rupture element 15 includes a rupture detector. The rupture detector includes an electrical wire 42 (cf. FIG. 4) fixed to the retaining part 35 on the downstream side and arranged in a loop. The electrical wire 42 extends into the protective tube 41 as far as a connection unit 43. The electrical wire 42 extends over almost the entire diameter of the rupture element 15, with a portion of wire 42a arranged on one side of a radial groove 36 parallel to the said radial groove 36 and the other portion of wire 42b arranged radially on the other side of the same radial groove 36 parallel to the said radial groove 36. The distance between the two wire portions 42a, 42b is small. This distance may be less than the maximum distance separating two through-holes 37 such that the wire 42 is disposed between the through-holes 37.

The electrical wire 42 is covered by a protective film which serves both to prevent it from corroding and to bond it to the downstream face of the retaining part 35. The composition of this film will also be chosen to avoid modifying the rupture pressure of the rupture element 15. The film may be made of embrittled polyamide. The breakage of the rupture element necessarily leads to the cutting of the electrical wire 42. This cutting can be detected in an extremely simple and reliable manner by the interruption of a current flowing through the wire 42 or by the voltage difference between the two ends of the wire 42.

The rupture element 15 also includes a strengthening part 44 arranged between the disc-shaped flanges 33 and 34 in the form of a metal sheet, for example made of stainless steel, aluminum, or aluminum alloy, cf. FIGS. 2 and 5. The thickness of the strengthening part 44 may be between 0.2 mm and 1 mm The strengthening part 44 includes a plurality of lobes, for example five, separated by radial slots 45 formed over the entire thickness lobes. The slots 45 can form tearing areas. The lobes are connected to an external annular edge. A folding areas 46, for example a slot arc shaped, may be formed over the entire thickness of each lobe except near neighboring lobes, thus giving the lobes an ability of being distorted axially. The folding area 46 may be torn on a upstream part of the thickness to ease the lobes fold toward the downstream side. One of the lobes is connected to a central polygon 47, for example by welding. The central polygon 47 closes the centre of the lobes and rests on hooks 48 fixed to the other lobes and axially offset with respect to the lobes such that the central polygon 47 is arranged axially between the lobes and the corresponding hooks 48. The polygon 47 may come into contact with the bottom of the hooks 48 to press axially thereon. The strengthening part 44 provides good axial strength in one direction and a very low axial strength in the other direction, the direction of rupture of the rupture element 15. The strengthening part 44 is particularly useful when the pressure in the tank 2 of the transformer 1 is lower than that of the depressurization chamber 16, which may arise if a partial vacuum is created in the tank 2 for the filling of the transformer 1. Between the retaining part 35 and the strengthening part 44, there may be arranged an impermeable part 49 including a thin film 50 of impermeable synthetic material, for example based on polytetrafluoroethylene surrounded on each face by a thick film 51 of precut synthetic material preventing the thin film 50 from becoming perforated by the retaining part 35 and the strengthening part 44. Each thick film 51 may include synthetic material for example based on polytetrafluoroethylene with a thickness in the order of 0.1 mm to 0.3 mm The thick films 51 may be precut in the form of an arc of a circle of about 330°. The thin film 50 may have a thickness in the order of 0.005 mm to 0.1 mm.

The rupture element 15 provides good resistance to the pressure in one direction (here, from downstream to upstream), a calibrated resistance to the pressure in the other direction (here, from downstream to upstream), excellent impermeability and low lag upon breakage. The rupture element 15 has to be understood as a quick rupture element because the delay between the occurence of the overpressure in the main tank 2 and the rupture of the rupture element 15 is about milliseconds and directly linked to the speed of propagation of waves in the cooling liquid 7.

To improve the impermeability, the rupture element 15 may include a washer 52 arranged between the disc-shaped flange 33 and the strengthening part 44 and a washer 53 arranged between the disc-shaped flange 34 and the retaining part 35. The washers 52 and 53 may be made of a polytetrafluoroethylene-based material.

In other words, a function of the rupture element 15 is that of a mechanical circuit breaker designed to break up, in the event of anomalous pressure, instead of other parts of the transformer which are replaceable with more difficulty. A function of the rupture element 15 is to release the said anomalous pressure in the tank 2. The pressure gradient resulting from a default in the electrical insulation is reversed. The rupture element 15 bursts in a predetermined way avoiding the tank 2, and other parts of the transformer 1, to undergo irreversible deformation subsequent to a strong pressure gradient.

The liquid detected by the liquid detector 24 can come from a leak of the rupture element 15, cf. FIG. 3. The liquid detected by a liquid detector 24 can come from a condensation near the rupture element 15. The liquid detector 24 is disposed downstream the rupture element 15. The liquid detector 24 is disposed upstream depressurization chamber 16, cf. FIG. 1. The liquid detector 24 is fixed, here, on the disc-shaped flange 34 of the rupture element 15, cf. FIG. 6. The liquid detector 24 includes an active part 71. The active part 71 is in fluidic communication with the interior of the device, here the internal part of the disc-shaped flange 34. The disc-shaped flange 34 includes a radial hole 80. The said fluidic communication can be carried out by the radial hole 80 of the disc-shaped flange 34. The radial hole 80 is radially crosses through, from an internal to an external surface, the disc-shaped flange 34. The liquid detector 24 is disposed, here, in the hole 80 arranged in the disk-shaped flange 34. The zone 40 located downstream the rupture element 15, upstream the depressurization chamber 16 and inside the disc-shaped flange 34 is in fluidic communication with the active part 71 of the liquid detector 24, cf. FIGS. 1 and 6. The disc-shaped flange 34 includes a collecting slot 81 for liquid. The collecting slot 81 is disposed downstream the rupture element 15. The collect slot 81 is configured to lead, by gravity, the flow of a possible liquid toward the hole 80. The active part 71 of the liquid detector 24 being placed near the rupture element 15, it detects quickly a leak of the rupture element 15. The distance between the rupture element 15 and the liquid detector 24 can be lower than 80 millimeters.

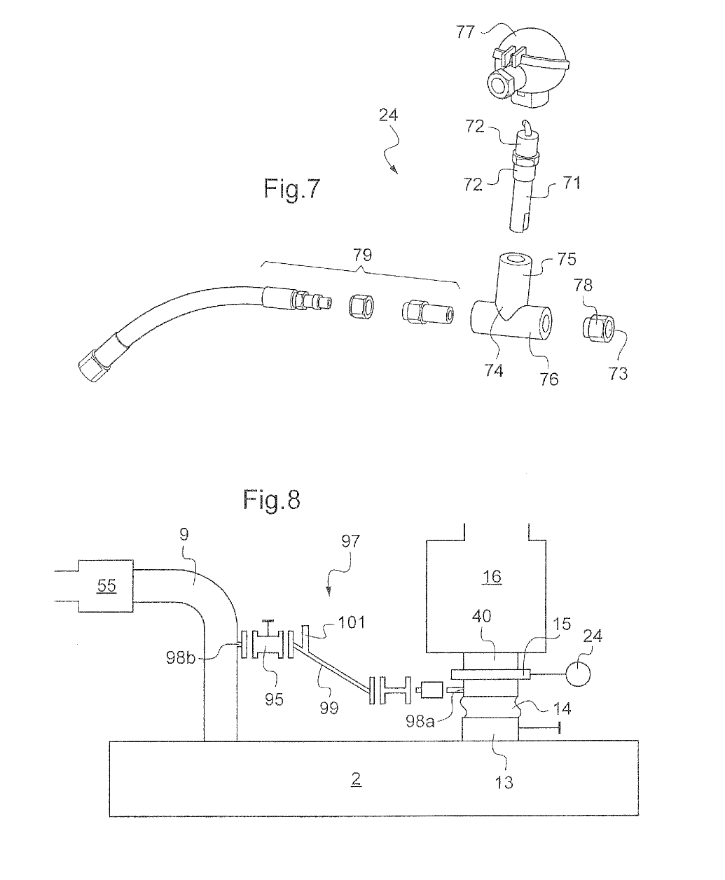

The liquid detector 24 can include linking elements 79, for example a flexible tube, a nut and a sleeve, cf. FIG. 7. The linking elements 79 let in fluidic communication the zone 40 located downstream the rupture element 15 and the active part 71 of the liquid detector 24.

The liquid detector 24 includes, here, a T-tube 74. The T-tube 74 is located downstream the linking elements 79. The T-tube 74 let a fluidic communication between the linking elements 79 and the active part 71 of the liquid detector 24. The T-tube 74 includes an upper leg 75 supporting the active part 71. The T-tube 74 includes a lower legs 76 provided with a bleed valve 78.

The active part 71 of the liquid detector 24 is, here, a liquid sensor 71. The liquid sensor 71 includes a tubular body here provided with external threadings 72 which insure fixation by screwing of the liquid sensor 71. One of the said threadings of the tubular body 72 of the liquid sensor 71 can be assembled with an interface 77. The liquid sensor 71 can for example be ultrasonic.

The interface 77 is electronically connecting the liquid sensor 71 to the control unit 23 or any other instruments of information collection. The bleed valve 78 is located at an altitude lower than the remainder of the liquid detector 24, here on the lower leg 76 of the T-tube 74. The bleed valve 78 makes it possible to extract the liquid without dismounting the liquid detector 24. The bleed valve 78 is closed in normal position, i.e. during normal operation of transformer 1 and open in transitory position of drainage.

The liquid detector 24 includes, here, a sight window 73 of a liquid presence. The sight window 73 comprises a transparent element which makes it possible to an operator to visually check the presence of liquid.

In the embodiment of FIG. 7, the sight window 73 and the bleed valve 78 have a body common portion.

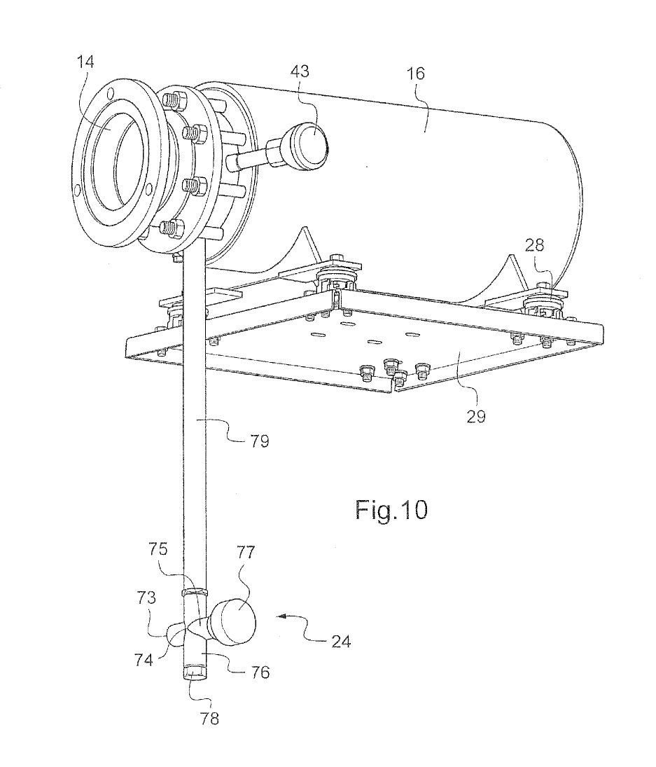

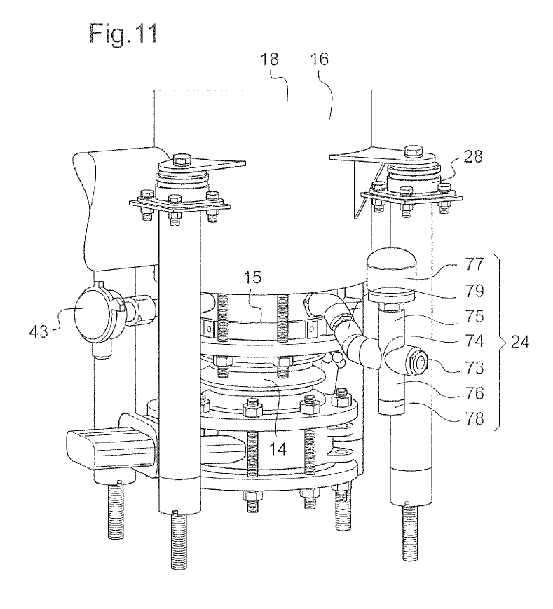

In other embodiments, represented on FIGS. 6, 9, 10 and 11, tube 74 is shaped as a X-tube instead of a T-tube. The supplementary leg of the tube 74 support a sight window 73 distinct from the bleed valve 78.

The T-tube or X-tube 74 can be configured to be adapted to preexistent configurations of a transformer for mounting a liquid detector 24. The extrinsic configuration of the liquid detector elements is in accordance with the behavior of liquids under gravity. In other words, the liquid sensor 71 is located in a collection zone filled in first, if the need anises, by the liquid, to detect a volume as small as possible of a leak.

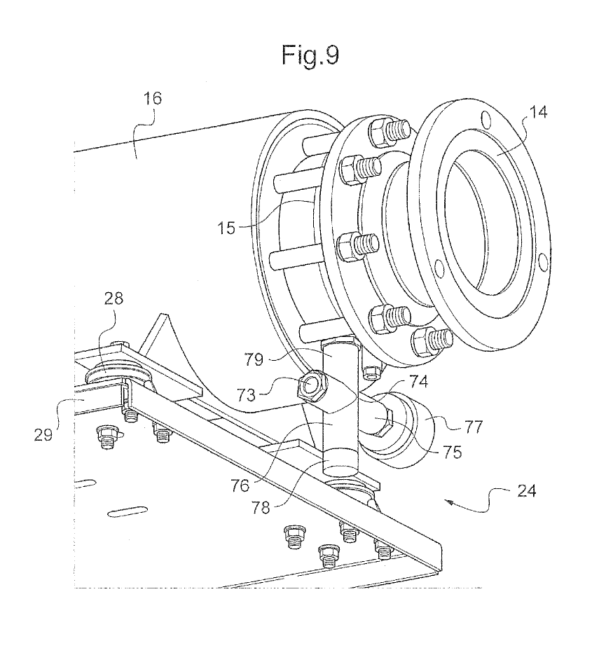

The shape of the liquid detector 24 and particularly the shape of the linking elements 79, can be adapted to many preexistent configurations of electric transformers 1, cf. FIGS. 9 to 12.

The depressurization chamber 16 has a higher diameter than the diameter of the rupture element 15. The depressurization chamber 16 is disposed downstream the rupture element 15. The depressurization chamber 16 is mounted upstream the second elastic sleeve 14. The depressurization chamber 16 is laid out with its principal axis aligned with the direction of the outlet of a flow passing through the rupture element 15 upon rupture. As shown on FIG. 1, elements of the prevention device located upstream the depressurization chamber 16 and downstream the tank 2, let a straight and short passage to the depressurization chamber 16 at the time of the rupture of the rupture element 15. The straight and short passage makes it possible to ensure a weak pressure loss of outgoing flow. The depressurization chamber 16 can be supported by dampers 28 supported by a bracket 29 fixed at the body 2a of the tank 2. A mechanical isolation absorbs partially vibrations transmitted from the electric transformer 1 in service to the depressurization chamber 16. The mechanical isolation is also improved by the elastic sleeve 14. The depressurization chamber 16 can be designed as a portion of tube with a diameter higher than the diameter of the first drainage pipe 17 located downstream. The depressurization chamber 16 can advantageously be designed to resist to higher pressure and higher mechanical efforts than the collection reservoir 18, located downstream the first drainage pipe 17. The depressurization chamber 16 reduces the speed of outgoing flow through the rupture element 15 and absorbs kinetic energy of the flow.

The second elastic sleeve 14 is similar to the first elastic sleeve. The second elastic sleeve 14 is disposed downstream the depressurization chamber 16. The second elastic sleeve 14 is mounted upstream the first drainage pipe 17. The second elastic sleeve 14 ensures the continuity of the communication between the depressurization chamber 16 located upstream and the first drainage pipe 17 located downstream. The second elastic sleeve 14 is designed to absorb partially vibrations transmitted from the depressurization chamber 16 to the first drainage pipe 17 located downstream.

The first drainage pipe 17 is laid out downstream the depressurization chamber 16, cf. FIG. 1. The first drainage pipe 17 is laid out upstream the collection reservoir 18. The dimension of the first drainage pipe 17 is chosen to allow a fast evacuation of fluid flow after the rupture element breaking.

The collection reservoir 18 is located downstream the first drainage pipe 17, cf. FIG. 1. The collection reservoir 18 is a space of storage for liquid and gases coming from the tank 2 after rupture element 15 breaking. The collection reservoir 18 allows to separate the liquid fraction from the gas fraction, for example by decantation, after reception of flow coming from the tank 2.

The collection reservoir 18, here, includes cooling fins 18a. The cooling fins 18a accelerate the cooling of the fluid from the tank 2 and reduces the fire hazards. The collection reservoir 18 is equipped, with an evacuating piping 19 for gases from the tank 2. The evacuating piping 19 can be connected, in a temporary way, to a mobile vessel to drain the collection reservoir 18. The tank 2 is depressurized immediately and later partially emptied in the collection reservoir 18. The evacuating piping 19 is provided, with an outlet valve 20. The outlet valve 20 prevents the entry of oxygen present in air thus reducing risks of combustion of gases and combustible liquid in the collection reservoir 18 and the tank 2. The outlet valve 20 prevents an uncontrolled evacuation of gas or liquid. The outlet valve 20 is constantly close in the normal operation to maintain the collection reservoir 18 hermetic. The outlet valve 20 can be open when the collection reservoir 18 is emptied of fluids which are in, or during drainage.

The collection reservoir 18 can include a system for cooling of the liquid stored by injection and mixing of an inert gas, such as nitrogen, in the bottom of the collection reservoir 18, cf. FIG. 1. The inert gas in stored in a pressurized tank provided with a valve, a pressure reducer or a regulator pressure and a pipe leading gas until the bottom of the collection reservoir 18. The pressurized tank can be placed in the cabinet 22. The cooling system can be mainly common with a system of cooling of the tank 2 already described.

The fire detector 11, the rupture elements 15, the automatic valve 10, the sensor of the rupture element breaking, the outlet valve 20 and/or the cabinet 22 can be connected to the control unit 23 designed to control the operation of the device, cf. FIG. 1. The control unit 23 can be provided with systems for processings information, receiving signals of sensors and emitting control signals.

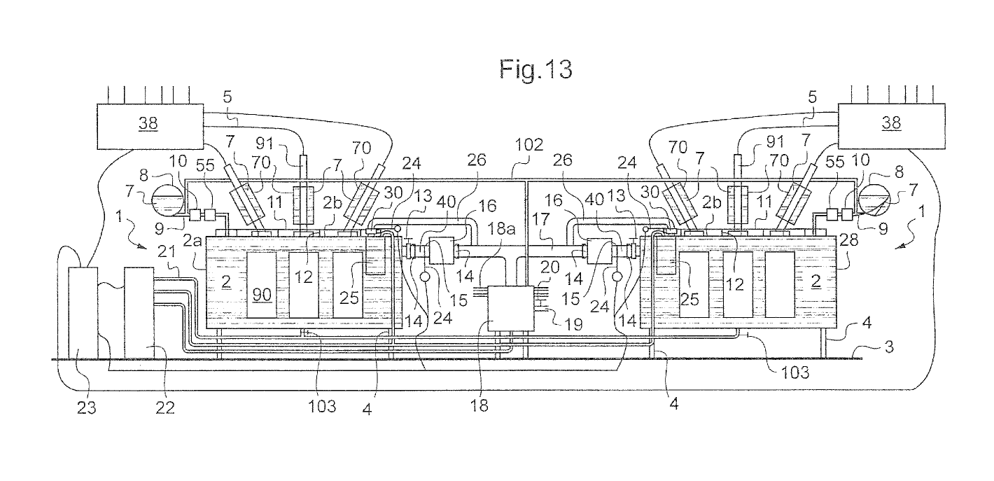

Several electric transformers 1 can be connected to a common collection reservoir 18, cf. FIG. 13. In other words, several devices of prevention of several transformers 1 can include a collection reservoir 18 and/or parts of first drainage pipe 17 in common These embodiments are particularly advantageous in confined places or in places where available space is restricted.

As shown on FIG. 1, the transformer 1 may be equipped with one or more on-load tap changers 25 serving as interface between the transformer 1 and the electrical power grid to which it is connected in order to provide a constant voltage despite variation in the current supplied to the network.

The on-load tap changer 25, here, is located in the main tank 2. The on-load tap changer 25 has its own tank. The tank of the on-load tap changer 25 fluidly isolates the on-load tap changer 25 from the cooling liquid 7 present in the tank 2. The tank of the on-load tap changer 25 is inserted in the tank 2. The tank of the on-load tap changer 25 bathes in the cooling liquid 7 of the tank 2. The on-load tap changer 25 is also cooled by a cooling dielectric liquid, generally oil, similar or not with that of the tank 2. The on-load tap changer 25 can have a conservator. Each conservator can be provided independently with Buchholz, cf. EP 0 957 496, paragraph 30. Due to its high mechanical strength, the explosion of an on-load tap changer 25, if the need arises, is extremely violent and can be accompanied by the ejections of jets of burning coolant liquid.

The on-load tap changer 25 is connected by a second drainage pipe 26 to the first drainage pipe 17. The second drainage pipe 26 is equipped with a rupture element 30. The rupture element 30 can be similar to the rupture element 15 of the tank 2 previously described, adapted in dimensions to the on-load tap changer 25. The rupture element 30 can include a liquid detector 24. The rupture element 30 is able of tearing in the event of a short-circuit and therefore of excess pressure inside the on-load tap changer 25. The risk of explosion of the on-load tap changer 25 tank is decreased. The working of the protection device on the on-load tap changer 25 is relatively similar to the working of the protection device on the transformer 1. The second drainage pipe 26 can from a depressurization chamber, the volume of fluids at this outlet of the on-load tap changer being quite lower than that of the tank 2, cf. FIG. 1.

The feedtroughs 91 isolate the main tank 2 of an electric transformer 1 from high and low tension lines which are connected to the main windings 90 of the electric transformer 1 via electrical lines 5. Each feedthrough 91 can be surrounded by a tank 70 containing dielectric liquid. The liquid of feedthroughs 91 is separated from the main tank 2. The prevention device against explosion is adapted for main tank 2 of an electric transformer 1, for the tank of an on-load tap changer 25, and for tanks 70 of feedthroughs 91, so called “oil boxes”.

The maintenance valve 13 can be close for maintenance operations, the electric transformer 1 being out of service. In service of the transformer 1, the maintenance valve 13 is open and the rupture elements 15, 30 are intact, i.e. closed. The outlet valve 20 is also closed. The elastic sleeves 14 are able to absorb vibrations of the electric transformer 1 during service and during a short-circuit, to avoid transmitting vibrations to others elements, in particular to the rupture element 15.

The rupture element 15 could be designed to open at a pressure lower than 1 bar, for example ranging between 0.6 and 1 bar, preferably between 0.8 and 1 bar. At the time of the bursting of the rupture element 15, following an electric default in the electric transformer 1, the pressure in tank 2 decreases. A jet of gas and/or liquid gets through the rupture element 15 open and spreads in the depressurization chamber 16, then flows out in the first drainage pipe 17 toward the collection reservoir 18. The function of the depressurization chamber 16 can be particularly important during the first milliseconds from the bursting of the rupture element 15. The depressurization chamber 16 lets evacuate a strong flow at the time of the bursting of the rupture element 15, thanks to extremely low pressure losses.

Later, an inert gas injection, for example nitrogen, can be carried out in the bottom of the tank 2 to lead out combustible gases which can remain in the tank 2 and to cool by mixing the hot parts of the liquid of the electric transformer 1 to stop the production of gases. The inert gas injection can be started from few minutes to few hours after the rupture of the rupture element 15.

Preferably, duration of decantation in the collection reservoir 18 is sufficient so that the gases and the liquid separate. Moreover, it is possible to wait for the cooling of the collection reservoir 18 and its contents. A mobile vessel may be connected to the evacuating piping 19 in order to receive the fluid present in the collection reservoir 18, by opening of the outlet valve 20. The collection reservoir 18 may be purged with an inert gas. The combustible gases are extracted from collection reservoir 18 towards a suitable mobile vessel. The rupture element 15 can be replaced. For safety reasons, the tank of inert gas is disposed to inject inert gases for about 45 minutes, which can be useful to cool the cooling liquid 7 and the hot parts by mixing of the liquid and stop the production of gas by decomposition of the cooling liquid 7.

In the event of incident in the tank 2 respectively in the tank of the on-load tap changer 25, for example a short-circuit, the pressure increases suddenly. If the threshold of pressure predetermined is reached, the rupture element 15, respectively 30, bursts and opens brutally according to expected operation. The opening lets evacuate a volume of liquid and/or gas quickly. The internal pressure quickly goes down inside the said tank. The detection of the rupture of the rupture element 15, respectively 30, causes the triggering of mixing by inert gas after a selected delay. The volume of fluid passing by the rupture element 15, respectively 30, is drained toward the collection reservoir 18 while passing the depressurization chamber 16. Transformer 1 is stopped, for example by the triggering of the supply cell 38. Reparation, in particular the replacement of the rupture element 15, respectively 30, can take place. The probability of preserving the integrity of the tanks increases.

The inert gas injection by bottom, by using an additional portion of tube laid out in the tank of the on-load tap changer 25, rather than by the top, of the tank of the on-load tap changer 25 allows a better mixing. A mixing by the top of the tank of the on-load tap changer 25 has a less interest in term of mixing. A mixing by the top of the tank of the on-load tap changer 25 could, in addition, facilitate the circulation of air and kindle flames in the event of fire. This solution has to be proscribed.

The existing devices do not allow to detect or evacuate passively an accumulation of gas upstream the rupture element. However, this accumulation can be an indication of anomaly which have variable importance and can present a risk of accumulation of explosive gases. The degassing device comes to improve the protection device while detecting and evacuating the gas accumulation.

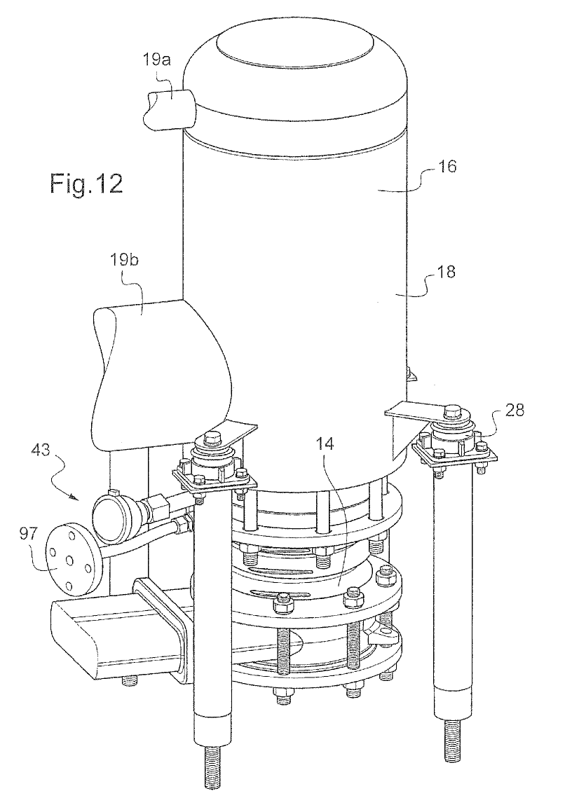

The degassing device, cf. FIGS. 8 and 12, is provided, here, with a passive degassing component 97 and with a gas sensor 55. The passive degassing component 97 ensures, here, a fluidic communication between the space upstream the rupture element 15 and the inside of the first pipe 9 conecting conservator 8 to the tank 2.

In the embodiment shown on FIG. 8, with a single gas sensor 55, the gas sensor 55 has to be disposed at an altitude the most adapted to the possible presence of gas.

The passive degassing component 97 allows the degasification of the zone located upstream the rupture element 15, on the side of the tank 2.The said zone is filled by cooling liquid 7 of the tank 2 in normal operation.

The passive degassing component 97 includes, here, an end 98a laid out in the zone located upstream the rupture element 15. The end 98a of the passive degassing component 97 is fixed near the rupture element 15. The distance between the said end 98a and the rupture element 15 is preferably lower than 70 millimeters. The passive degassing component 97 includes here an end 98b emerging in the first pipe 9. The passive degassing component 97 includes here an end 98b fixed to the first pipe 9. The passive degassing component 97 includes here a monotone gradient tube 99. The monotone gradient tube 99 can, for example, have a slope from 0 to 10%, preferably from 3 to 5%.

As shown on FIG. 8, the passive degassing component 97 includes, here, a maintenance valve 95. The maintenance valve 95 is constantly open in normal operation and can be closed during maintenance operation. The passive degassing component 97 can be in a constant active state. The passive degassing component 97 includes here a connection 101 which can be closed during normal operation. The connection 101 may be a quick coupling. The connection 101 makes it possible to connect an apparatus of partial vacuum to the passive degassing component 97. The partial vacuum can be carried out during maintenance operation. The partial vacuum creates a light depression inside the system limiting consequences of a pressure gradient. The partial vacuum reduces the quantity of oxygen present in the system.

As shown on FIG. 1, the second degassing component 102 can be connected to the first pipe 9. The second degassing component 102 fluidly links the first pipe 9 to the collection reservoir 18. In an alternate embodiment, the second degassing component 102 can fluidly connect the first pipe 9 to the first drainage pipe 17. In the event of overpressure in conservator 8 and the first pipe 9, a volume of fluid (liquid and/or gas) can directly be evacuated from the tank 2.

In an embodiment, the first pipe 9 and the said zone upstream the rupture element 15 can include a common section near the tank 2. This embodiment is particularly interesting for installations whose horizontal surface is limited. An important part of the device can be laid out above the tank 2. In contrary, if the available height is limited, for example in basement, an important part of the device can be laid out at an altitude equivalent to the altitude of the tank 2.

The passive degassing component ensures a fluidic communication between the zone located immediately upstream the rupture element 15 and the gas sensor 55 allowing the accumulated gas detection upstream the rupture element 15.

The passive degassing component 97 can be adapted to many configurations of electric transformers 1 existing, cf. FIG. 12.

In the embodiment shown on FIGS. 8, 11 and 12, the prevention device is laid out vertically, for example on the lid 2b of the tank 2. The depressurization chamber 16 has a vertical axis. The depressurization chamber 16 can include a tube closed at the higher end, the lower end being open and connected to the rupture element 15. The depressurization chamber 16 also forms the collection reservoir 18. As shown on FIG. 12, the evacuating piping 19a is connected to a higher zone of the cylinder of the depressurization chamber 16 for taking away gases. An evacuating piping 19b is connected to a lower zone of the tube of the depressurization chamber 16 for taking away liquids. This embodiment is particularly compact, the prevention device being located mainly at the top of the tank 2. The collection reservoir 18 can have a function of phase separation. The collection reservoir 18 can have a function of decantation.

The detection and safety device is inexpensive, autonomous compared to the neighboring installations, of low space occupied and requires little or no maintenance.

The assembly of the prevention device on a transformer requires few modifications of the transformer elements. The device reacts to short circuits extremely quickly limiting the resulting consequences, notably in confined places.

The insignificant production of gas in normal operation is evacuated outside the tank. The accumulation of gas bubbles and formation of gas pockets, which can be dangerous, are reduced. These gases are detected for a better control.

The invention makes it possible to very early detect tiny leaks of liquid through the rupture elements. These liquids be purged. The downstream face of the rupture element remains appreciably dry. There is little or no additional pressure losses, in the event of the rupture of the rupture element. The risk of explosion of the tank and in particular of the lid is decreased. Possible damage of a deformation is reduced. The tiny leak detection makes it possible to prepare a minor intervention of maintenance for example by replacing the rupture element at the time of a stand-by already scheduled, avoiding reduction of the availability ratio of the transformer in service. The device is adaptable to existing installations. The system on makes possible to detect leaks and accumulations of liquid (oil or water) before it becomes a serious risk). The invention makes it possible to control a liquid presence, for example of condensation, and improves detection of a possible anomaly of the rupture element.

A device in a normal state comprises an intact and seal rupture element. In this state, a first face defining the upstream side of the rupture element is oriented toward the tank. The first face is in contact with the cooling fluid contained in the tank. The first face is concave. The first face is wet because it is in contact with the cooling fluid. In the normal state, a second face, opposite to the first face, defines the downstream side of the rupture element. The second face is oriented toward the opposite of the tank. The second face is not in contact with the cooling fluid. The second face is in contact with gas contained in the drainage pipe and in the depressurization chamber. The second face is convex. The second face is dry because it is in contact with the gas. The liquid detector is arranged at the side of the second face of the rupture element. The liquid detector is arranged in such a way to detect presence of liquid on the second face of the rupture element or close to the second face. The position of the liquid detector is chosen to be as near as possible of the second face of the rupture element without to disturb the operation of the rupture element in the case of there is an overpressure in the tank and a rupture element triggering. The presence of liquid at the downstream side of the rupture element could be result from sealing defect of the rupture element or from condensation phenomena. This unwished presence of liquid, which is in exception of that a normal operation state, could be detrimental to the proper functioning of the device if there is a future burst of the rupture element. The detection of this liquid allows to generate a monitoring information to decide (or not) a maintenance operation to eliminate the unwanted liquid at this side of the rupture element.

In a safety-mode, which means when the rupture element is triggering because of an overpressure in the tank, the liquid detector detects the presence of cooling liquid evacuated through the burst rupture element. In this case, the detection of cooling liquid coming from inside the tank by the liquid detector is a consequence of the rupture element triggering. The liquid detector allows to detect the security device triggering such an additional mean with respect to others specific rupture detectors. The detection of the safety device triggering by the liquid detector increases the device reliability. For example, in case of dysfunction of the specific rupture detectors, the rupture element triggering will be detected by the liquid detector. The liquid detector has a supplementary function that is to detect the safety device triggering.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. Device for preventing the explosion of an electrical transformer provided with a tank which is filled with a coolant liquid, the device comprising a rupture element provided with tear areas and folding areas at breaking, said rupture element being able to break when the internal tank pressure exceeds a predetermined threshold, and at least one flange for maintaining said rupture element, said flange being arranged at side of the rupture element opposite the tank, characterized in that it comprises a liquid detector arranged at the side of the rupture element opposite the tank.

2. Device according to claim 1, wherein the liquid detector is mounted in a hole provided on the flange.

3. Device according to claim 1, wherein the liquid detector comprises a tubular body having external threads.

4. Device according to claim 1, wherein the liquid detector comprises a liquid display window.

5. Device according to claim 1, wherein the liquid detector comprises an upper leg supporting a liquid sensor and a lower leg provided with a bleed valve.

6. Device according to claim 1, wherein the rupture element is cambered opposite the tank.

7. Device according to claim 1, wherein the flange includes a groove for collecting the liquid near the rupture element.

8. System for preventing the explosion of an electrical transformer provided with a tank filled with a coolant liquid, the system comprising a device according to one of precedent claims mounted in communication with said tank, said tank containing main windings, an on-load tap changer or a feedthrough.

9. System according to claim 8, comprising a conservator linked to the said tank by a first pipe, a gas sensor mounted on the first pipe and a passive degassing component an area upstream of the rupture element in communication with the gas sensor, the gas sensor being degassing-gas sensitive.

10. System according to claim 9, wherein the passive degassing component is permanent and the gas sensor is mounted higher than the rupture element.

11. System according to claim 9, wherein the passive degassing component comprises an end arranged in an area upstream of the rupture element, near the rupture element, the said end being at a distance from the rupture element smaller than seventy millimeters.

12. System according to claim 9, wherein the passive degassing component comprises an end fixed near the rupture element.

13. System according to claim 9, wherein the passive degassing component comprises an end fixed to the first pipe and a monotone gradient tube.

14. System according to claim 9, wherein the passive degassing component comprises a connection with a component to make partial vacuum.

15. System according to claim 9, wherein the first pipe comprises a second degassing component fluidly linked to a first pipe of emptying or to a collection tank.

16. System according to claim 9 comprising a tube for injecting inert gas by the lower of the tank, the said pipe being provided, near the said tank, of a non return valve.

17. System according to claim 9, wherein a depressurization chamber is based on at least one shock absorber, the said shock absorber being based on a console, the said console being embodied with the tank or the ground.
